(19) United States
(12) Patent Application Publication
(10) Pub. No.: US 2026/0243800 A1
(43) Pub. Date: Aug. 20, 2026

(54) SENSOR AND ELECTRONIC DEVICE

(71) Applicant: Kabushiki Kaisha Toshiba, Kawasaki-shi (JP)

(72) Inventors: Kengo UCHIDA, Kawasaki Kanagawa (JP); Kei MASUNISHI, Kawasaki Kanagawa (JP); Yasushi TOMIZAWA, Fuchu Tokyo (JP)

(21) Appl. No.: 19/451,315

(22) Filed: Jan. 16, 2026

(30) Foreign Application Priority Data
Feb. 20, 2025 (JP) 2025-026194

(51) Int. Cl. G01P 15/125

(52) U.S. Cl. CPC G01P 15/125

(57) ABSTRACT

According to one embodiment, a sensor includes a first structure, a first intermediate member, a sensor section, and a first fixing member. The first structure includes a first member region. The first intermediate member includes a first intermediate fixing region fixed to the first member region, and a first intermediate movable portion supported by the first intermediate fixing region. A first gap is provided between the first member region and the first intermediate movable portion. The sensor section includes a sensor base and a first sensor section. The first movable portion includes a first movable electrode. The first fixed electrode is fixed to the first region and faces the first movable electrode. A second gap is provided between the first region and the first movable portion. The first end portion is a free end.

### CROSS-REFERENCE TO RELATED APPLICATIONS

This application is based upon and claims the benefit of priority from Japanese Patent Application No.2025-026194, filed on February 20, 2025; the entire contents of which are incorporated herein by reference.

### FIELD

Embodiments described herein relate generally to a sensor and an electronic device.

### BACKGROUND

For example, acceleration and the like are detected by a sensor having a MEMS structure. It is desirable to improve the performance of the sensor.

### BRIEF DESCRIPTION OF THE DRAWINGS

FIGS. 1A and 1B are schematic cross-sectional views illustrating a sensor according to a first embodiment;

FIGS. 2A and 2B are schematic cross-sectional views illustrating the sensor according to the first embodiment;

FIG. 3 is a schematic plan view illustrating the sensor according to the first embodiment;

FIGS. 4A and 4B are schematic plan views illustrating the sensor according to the first embodiment;

FIG. 5 is a schematic plan view illustrating a sensor according to the first embodiment;

FIG. 6 is a schematic plan view illustrating the sensor according to the first embodiment;

FIG. 7 is a schematic plan view illustrating a part of the sensor according to the first embodiment;

FIGS. 8A and 8B are schematic plan views illustrating the part of the sensor according to the first embodiment;

FIGS. 9A to 9C are schematic cross-sectional views illustrating the part of the sensor according to the first embodiment;

FIG. 10 is a schematic diagram illustrating an electronic device according to a second embodiment;

FIGS. 11A to 11G are schematic diagrams illustrating applications of the electronic device according to the embodiment; and

FIGS. 12A and 12B are schematic diagrams illustrating applications of the sensor according to the embodiment.

### DETAILED DESCRIPTION

According to one embodiment, a sensor includes a first structure, a first intermediate member, a sensor section, and a first fixing member. The first structure includes a first member region. The first intermediate member includes a first intermediate fixing region fixed to the first member region, and a first intermediate movable portion supported by the first intermediate fixing region. A first gap is provided between the first member region and the first intermediate movable portion. The sensor section includes a sensor base and a first sensor section. The sensor base includes a first region, a second region, and a first end portion. The first intermediate movable portion is between the first member region and the second region in a first direction. The second region is fixed to the first intermediate movable portion. The first region is between the second region and the first end portion in a second direction crossing the first direction. The first fixing member is between the first intermediate movable portion and the second region. The first fixing member fixes the second region to the first intermediate movable portion. The first fixing member does not overlap the first region in the first direction. The first sensor section includes a first support portion, a first movable portion, and a first fixed electrode. At least a part of the first support portion is fixed to the first region. The first movable portion is supported by the first support portion. The first movable portion includes a first movable electrode. The first fixed electrode is fixed to the first region and faces the first movable electrode. A second gap is provided between the first region and the first movable portion. The first end portion is a free end.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

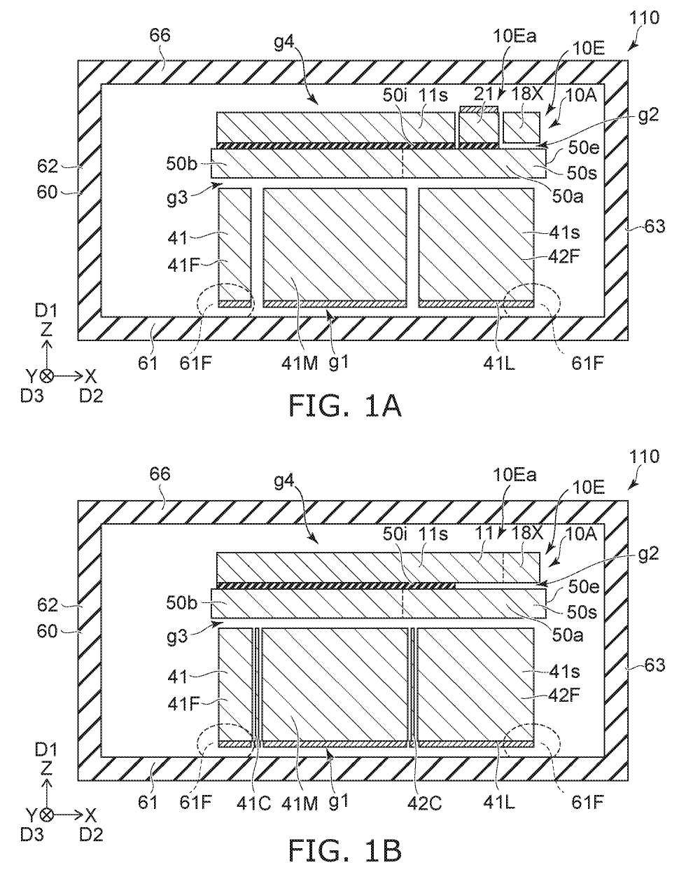

FIGS. 1A and 1B are schematic cross-sectional views illustrating a sensor according to a first embodiment.

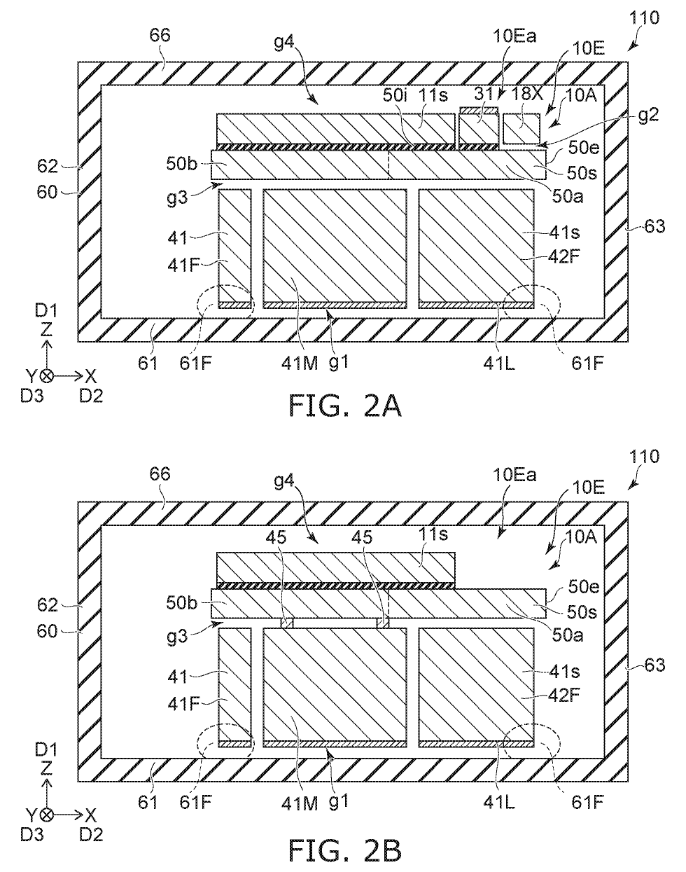

FIGS. 2A and 2B are schematic cross-sectional views illustrating the sensor according to the first embodiment.

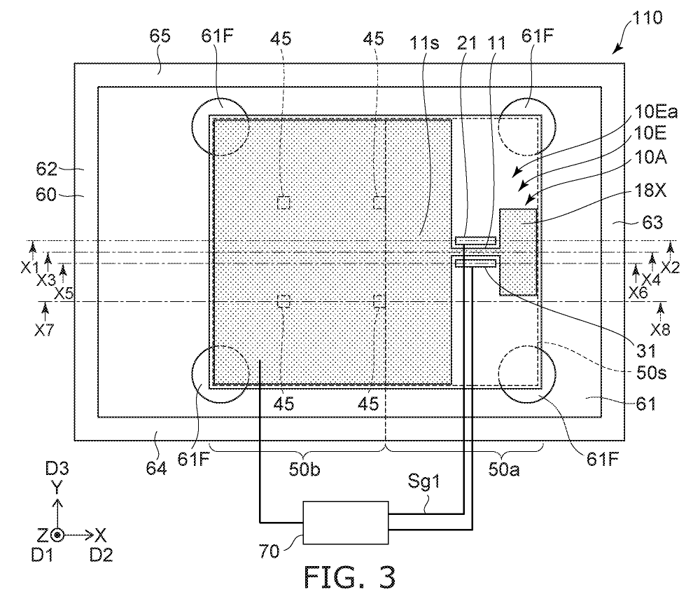

FIG. 3 is a schematic plan view illustrating the sensor according to the first embodiment.

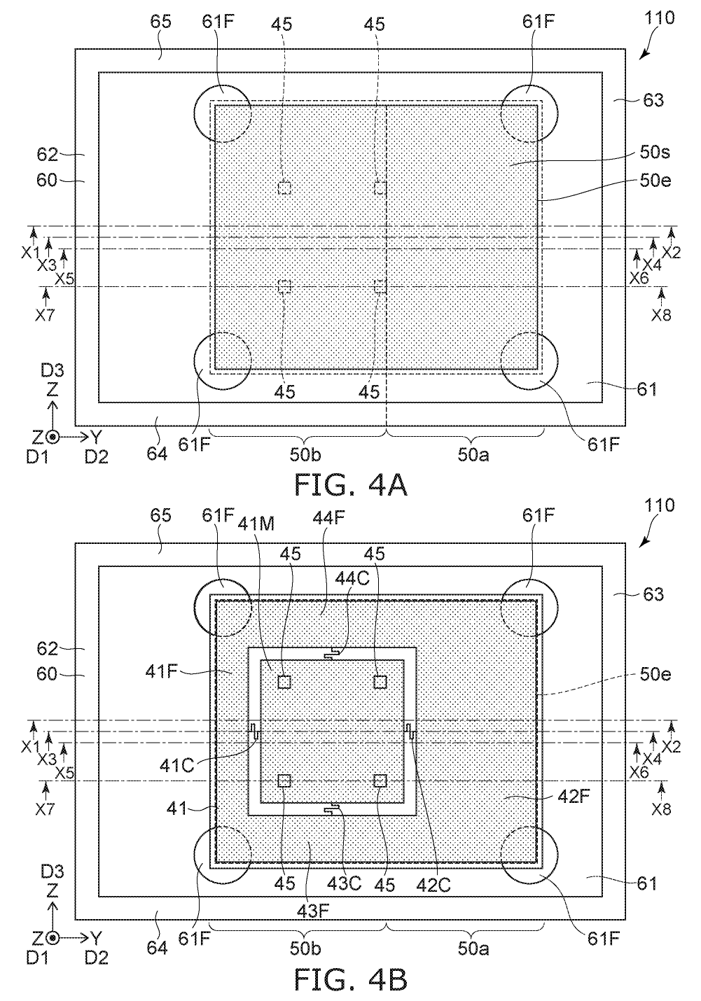

FIGS. 4A and 4B are schematic plan views illustrating the sensor according to the first embodiment.

FIG. 1A is a cross-sectional view taken along the line X1-X2 in FIGS. 3, 4A and 4B. FIG. 1B is a cross-sectional view taken along the line X3-X4 in FIGS. 3, 4A and 4B. FIG. 2A is a cross-sectional view taken along line the X5-X6 in FIGS. 3, 4A and 4B. FIG. 2B is a cross-sectional view taken along the line X7-X8 in FIGS. 3, 4A and 4B.

As shown in these figures, a sensor 110 according to the embodiment includes a first structure 60, a first intermediate member 41, a sensor section 10E, and a first fixing member 45. The first structure 60 includes a first member region 61. The first structure 60 may further include other member regions. Examples of the other member regions will be described later.

The first intermediate member 41 includes a first intermediate fixing region 41F and a first intermediate movable portion 41M. The first intermediate fixing region 41F is fixed to the first member region 61. In this example, the first intermediate fixing region 41F is fixed to the first member region 61 via a first mounting fixing member 61F, which will be described later. The first intermediate movable portion 41M is supported by the first intermediate fixing region 41F. A first gap g1 is provided between the first member region 61 and the first intermediate movable portion 41M.

The sensor section 10E includes a sensor base 50s and a first sensor section 10Ea. The sensor base 50s includes a first region 50a, a second region 50b, and a first end portion 50e. The first intermediate movable portion 41M is located between the first member region 61 and the second region 50b in a first direction D1.

The first direction D1 is defined as a Z-axis direction. One direction perpendicular to the Z-axis direction is defined as an X-axis direction. A direction perpendicular to the Z-axis direction and the X-axis direction is defined as a Y-axis direction.

The second region 50b is fixed to the first intermediate movable portion 41M. The first region 50a is between the second region 50b and the first end portion 50e in a second direction D2. The second direction D2 crosses the first direction D1. The second direction D2 may be, for example, the X-axis direction.

As shown in FIG. 2B, the first fixing member 45 is between the first intermediate movable portion 41M and the second region 50b. The first fixing member 45 fixes the second region 50b to the first intermediate movable portion 41M. The first fixing member 45 does not overlap the first region 50a in the first direction D1. The position of the first region 50a in the second direction D2 is between the position of the first fixing member 45 in the second direction D2 and the position of the first end portion 50e in the second direction D2.

The first sensor section 10Ea includes a first support portion 11s, a first movable portion 10A, and a first fixed electrode 21. At least a part of the first support portion 11s is fixed to the first region 50a. The first movable portion 10A is supported by the first support portion 11s. The first movable portion 10A includes a first movable electrode 11. The first fixed electrode 21 is fixed to the first region 50a and faces the first movable electrode 11. As shown in FIG. 1B, a second gap g2 is provided between the first region 50a and the first movable portion 10A. A part of the layer that becomes the first support portion 11s may overlap the second region 50b in the first direction D1.

As shown in FIGS. 1A, 1B, 2A and 2B, the first end portion 50e is a free end.

FIG. 3 is a plan view in the X-Y plane including the first support portion 11s and the first movable portion 10A. FIG. 4A is a plan view in the X-Y plane including the sensor base 50s. FIG. 4B is a plan view in the X-Y plane including the first intermediate member 41.

In one example, when a case where acceleration is applied to the sensor section 10E, a displacement occurs in the first movable portion 10A. When acceleration is applied to the sensor section 10E, for example, the mechanical characteristics of the first movable electrode 11 included in the first movable portion 10A change. For example, in a case where the first movable electrode 11 is beam-shaped, the vibration characteristics of the beam change. The applied acceleration can be detected by detecting the displacement or vibration characteristics of the first movable portion 10A. The change in the displacement or vibration characteristics can be detected by detecting the change in the electrostatic capacitance between the first movable electrode 11 and the first fixed electrode 21. The change in the displacement or vibration characteristics may be detected optically, for example. The sensor 110 is, for example, an acceleration sensor.

For example, in a case where a temperature change occurs in the sensor 110, the sensor section 10E may be subjected to stress due to a difference in the thermal expansion coefficient. For example, in a reference example, when the entire sensor base 50s is fixed, the sensor base 50s is likely to be deformed due to thermal stress, etc. The deformation may cause a change in detection characteristics. In the reference example, it is difficult to obtain sufficiently high detection accuracy.

In contrast, in the embodiment, the second region 50b of the sensor base 50s is fixed to the first intermediate movable portion 41M. On the other hand, the first region 50a where the first sensor section 10Ea is provided is not fixed to the first intermediate movable portion 41M. Since the first end portion 50e is a free end, the first end portion 50e can be freely displaced in response to temperature changes. In the embodiment, the effect of temperature changes can be suppressed.

Furthermore, the first intermediate movable portion 41M is supported by the first intermediate fixing region 41F. The first intermediate movable portion 41M is not directly fixed to the first member region 61. The relative positional relationship between the first intermediate movable portion 41M and the first member region 61 can be changed. For example, even in a case where the first member region 61 is deformed, the effect of the deformation on the first intermediate movable portion 41M is suppressed. The effect of the deformation on the second region 50b is suppressed. The first intermediate movable portion 41M functions as a stress relieving layer.

In the embodiment, the influence of various deformations on the detection characteristics is suppressed. In the embodiment, high detection accuracy is stably obtained. According to the embodiment, a sensor capable of improving performance can be provided.

In the embodiment, a first rate of change of the first curvature of the first region 50a in the second direction D2 with respect to temperature is smaller than a second rate of change of the second curvature of the second region 50b in the second direction D2 with respect to temperature. Deformation is suppressed in the first region 50a.

As shown in FIGS. 1A, 1B, 2A and 2B, a position of the first region 50a in the first direction D1 is between a position of the first member region 61 in the first direction D1 and a position of the first movable portion 10A in the first direction D1. At least a part of the first intermediate fixing region 41F may be between the first member region 61 and the second region 50b in the first direction D1.

A third gap g3 may be provided between the first intermediate fixing region 41F and the second region 50b. For example, heat conduction via the second region 50b and the first intermediate fixing region 41F is suppressed. More stable characteristics are easier to obtain.

As shown in FIG. 1B and FIG. 4B, the first intermediate member 41 may further include a first intermediate connecting portion 41C. The first intermediate connecting portion 41C is provided between the first intermediate fixing region 41F and the first intermediate movable portion 41M. The first intermediate connecting portion 41C connects the first intermediate movable portion 41M to the first intermediate fixing region 41F. A length of the first intermediate connecting portion 41C along a first extending direction in which the first intermediate connecting portion 41C extends is longer than a length of the first intermediate connecting portion 41C along a first extending crossing direction that crosses the first extending direction. The first intermediate connecting portion 41C may have, for example, a meandering structure. Low thermal conductivity and high flexibility are obtained.

The first intermediate member 41 may further include a second intermediate fixing region 42F fixed to the first member region 61. The second intermediate fixing region 42F supports the first intermediate movable portion 41M. The first intermediate movable portion 41M is located between the first intermediate fixing region 41F and the second intermediate fixing region 42F in a cross direction (e.g., the second direction D2) that crosses the first direction D1.

As shown in FIG. 1B and FIG. 4B, the first intermediate member 41 may further include a second intermediate connecting portion 42C provided between the first intermediate movable portion 41M and the second intermediate fixing region 42F. The second intermediate connecting portion 42C connects the first intermediate movable portion 41M to the second intermediate fixing region 42F. A length of the second intermediate connecting portion 42C along a second extending direction in which the second intermediate connecting portion 42C extends is longer than a length of the second intermediate connecting portion 42C along a second extending crossing direction that crosses the second extending direction. The second intermediate connecting portion 42C may have, for example, a meandering structure. Low thermal conductivity and high flexibility are obtained.

As shown in FIG. 4B, the first intermediate member 41 may further include a third intermediate fixing region 43F fixed to the first member region 61. The third intermediate fixing region 43F supports the first intermediate movable portion 41M. A direction from the first intermediate fixing region 41F to the first intermediate movable portion 41M crosses a direction from the third intermediate fixing region 43F to the first intermediate movable portion 41M. In this example, the direction from the first intermediate fixing region 41F to the first intermediate movable portion 41M is along the second direction D2. The direction from the third intermediate fixing region 43F to the first intermediate movable portion 41M is along a third direction D3. The third direction D3 crosses a plane including the first direction D1 and the second direction D2.

The first intermediate member 41 may further include a third intermediate connecting portion 43C provided between the first intermediate movable portion 41M and the third intermediate fixing region 43F. The third intermediate connecting portion 43C connects the first intermediate movable portion 41M to the third intermediate fixing region 43F. A length of the third intermediate connecting portion 43C along a third extending direction in which the third intermediate connecting portion 43C extends is longer than a length of the third intermediate connecting portion 43C along a third extending crossing direction that crosses the third extending direction. The third intermediate connecting portion 43C may have, for example, a meandering structure. Low thermal conductivity and high flexibility are obtained.

As shown in FIG. 4B, the first intermediate member 41 may further include a fourth intermediate fixing region 44F fixed to the first member region 61. The fourth intermediate fixing region 44F supports the first intermediate movable portion 41M. The first intermediate movable portion 41M is located between the third intermediate fixing region 43F and the fourth intermediate fixing region 44F.

The first intermediate member 41 may further include a fourth intermediate connecting portion 44C provided between the first intermediate movable portion 41M and the fourth intermediate fixing region 44F. The fourth intermediate connecting portion 44C connects the first intermediate movable portion 41M to the fourth intermediate fixing region 44F. A length of the fourth intermediate connecting portion 44C along a fourth extending direction in which the fourth intermediate connecting portion 44C extends is longer than a length of the fourth intermediate connecting portion 44C along a fourth extending crossing direction that crosses the fourth extending direction. The fourth intermediate connecting portion 44C may have, for example, a meandering structure. Low thermal conductivity and high flexibility are obtained.

The first intermediate fixing region 41F, the second intermediate fixing region 42F, the third intermediate fixing region 43F, and the fourth intermediate fixing region 44F may be continuous with each other. The boundaries of these regions may be clear or unclear.

As shown in FIG. 1A and FIG. 3, the sensor 110 may include a first mounting fixing member 61F. The first mounting fixing member 61F fixes the first intermediate fixing region 41F to the first member region 61. The first mounting fixing member 61F may fix the second intermediate fixing region 42F to the first member region 61. The first mounting fixing member 61F may fix the third intermediate fixing region 43F to the first member region 61. The first mounting fixing member 61F may fix the fourth intermediate fixing region 44F to the first member region 61.

As shown in FIG. 1A, the first intermediate member 41 may include a first intermediate member layer 41s and a first intermediate film 41L. The first intermediate film 41L is between the first member region 61 and the first intermediate member layer 41s. The first intermediate member layer 41s may include, for example, silicon. The first intermediate film 41L may include a metal, etc. The first mounting fixing member 61F may include, for example, a solder, etc.

As shown in FIG. 1A and FIG. 4B, the first structure 60 may include a second member region 62, a third member region 63, a fourth member region 64, and a fifth member region 65. These member regions may be connected to the first member region 61. For example, the first intermediate member 41 and the sensor section 10E are between the second member region 62 and the third member region 63 in the second direction D2. For example, the first intermediate member 41 and the sensor section 10E are between the fourth member region 64 and the fifth member region 65 in the third direction D3.

As shown in FIG. 1A, the first structure 60 may further include a facing member region 66. The first intermediate member 41 and the sensor section 10E are provided between the first member region 61 and the facing member region 66. A fourth gap g4 is provided between the sensor section 10E and the facing member region 66. The facing member region 66 is omitted in FIG. 3, FIG. 4A and FIG. 4B. The facing member region 66 may be connected to the second member region 62, the third member region 63, the fourth member region 64 and the fifth member region 65. The first intermediate member 41 and the sensor section 10E are provided in a space surrounded by such a plurality of member regions. The space may be depressurized. More stable detection is possible.

The first support portion 11s and the first movable portion 10A are conductive. A part of the first movable portion 10A may function as the first movable electrode 11. The first support portion 11s and the first movable portion 10A may include conductive silicon or the like.

As shown in FIG. 3, a controller 70 may be provided in the sensor 110. The controller 70 may be included in the sensor 110. The controller 70 may be provided separately from the sensor 110. The controller 70 may be configured to detect a first signal Sg1 generated between the first movable electrode 11 and the first fixed electrode 21. The first signal Sg1 changes depending on the acceleration applied to the sensor section 10E.

As shown in FIG. 3, the first sensor section 10Ea may further include a first other fixed electrode 31 fixed to the first region 50a. The first movable electrode 11 is between the first other fixed electrode 31 and the first fixed electrode 21. In this example, a direction from the first other fixed electrode 31 to the first fixed electrode 21 is along the third direction D3.

In one example, a first AC signal (first AC voltage) is applied between the first other fixed electrode 31 and the first movable electrode 11. This may cause the first movable electrode 11 to vibrate. The vibration characteristics of the first movable electrode 11 may be detected by the first fixed electrode 21. The functions of the first fixed electrode 21 and the first other fixed electrode 31 may be interchanged.

In the example shown in FIG. 3, the first movable portion 10A includes a first movable component 18X. In this example, the first movable component 18X is connected to the first movable electrode 11. For example, in the second direction D2, the first movable electrode 11 is between the first support portion 11s and the first movable component 18X. The first movable component 18X is, for example, a proof mass. Acceleration can be detected with high sensitivity. A length of the first movable component 18X in the third direction D3 is longer than a length of the first movable electrode 11 in the third direction D3.

As shown in FIG. 1A, a first intermediate layer 51i may be provided between the first region 50a and the first support portion 11s. The first intermediate layer 51i may be an insulating layer.

As shown in FIG. 3, FIG. 4A and FIG. 4B, in the example of sensor 110, the first intermediate member 41 includes a plurality of first fixing members 45. The number of the plurality of first fixing members 45 is arbitrary. The first fixing members 45 may include, for example, Si. The first fixing members 45 may include a metal (for example, at least one selected from the group consisting of Au and Cu).

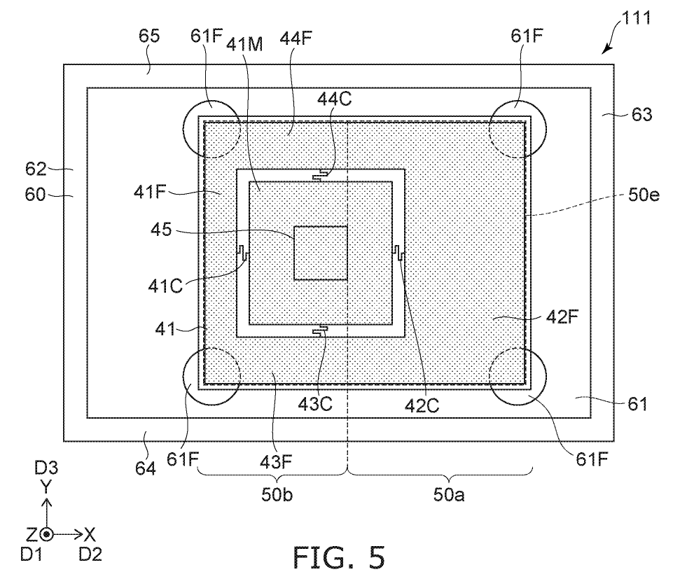

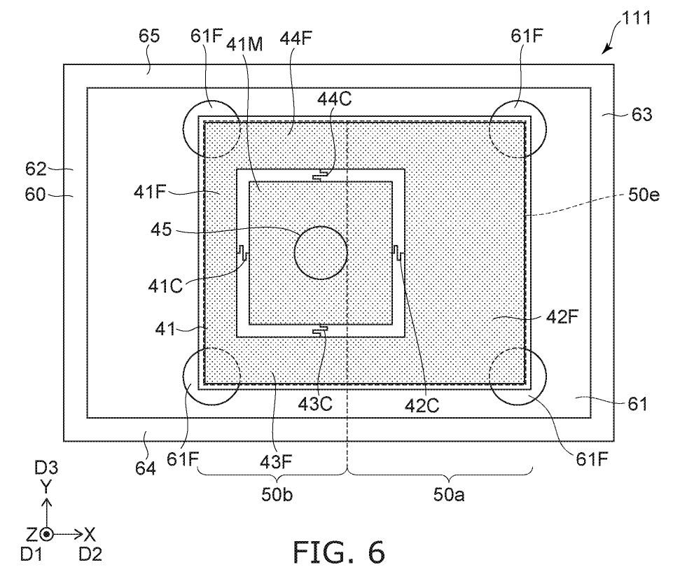

FIGS. 5 and 6 are schematic plan views illustrating a sensor according to the first embodiment.

As shown in FIGS. 5 and 6, in sensors 111 and 112 according to the embodiment, one first fixing member 45 is provided. The planar shape of the first fixing member 45 may be polygonal or circular, for example.

Other examples of the first sensor section 10Ea will be described below.

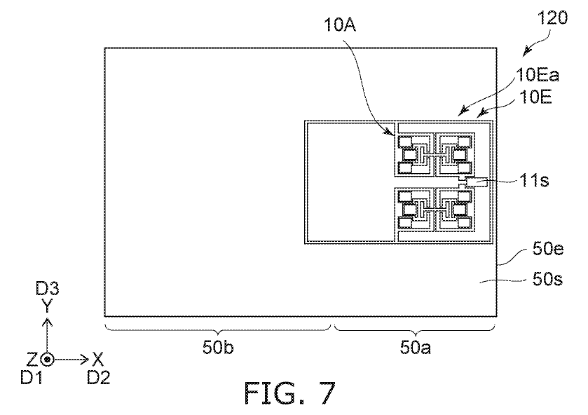

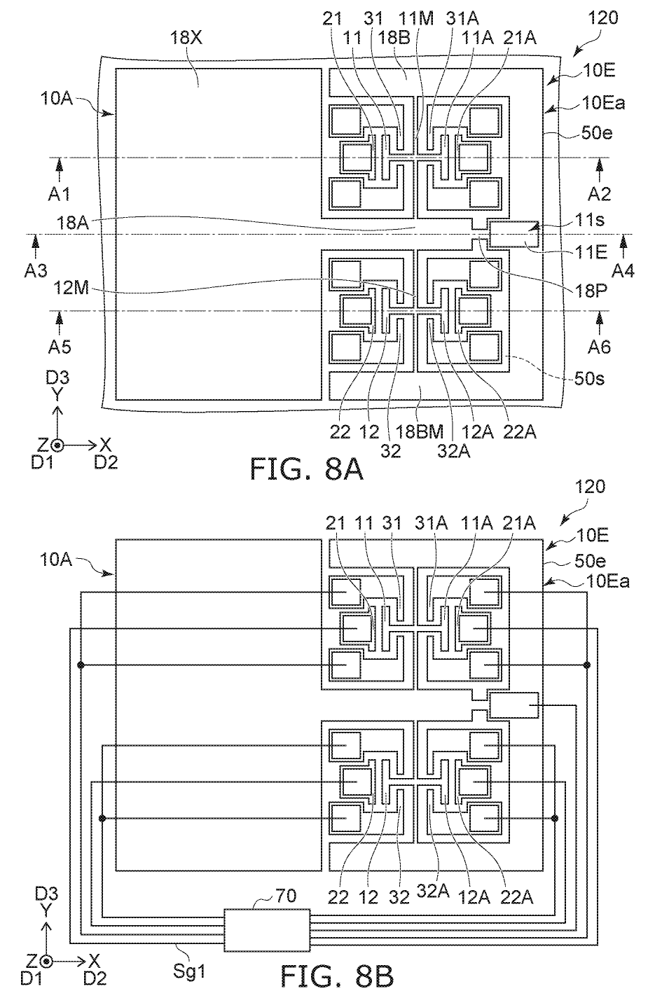

FIGS. 7, 8A and 8B are schematic plan views illustrating a part of the sensor according to the first embodiment.

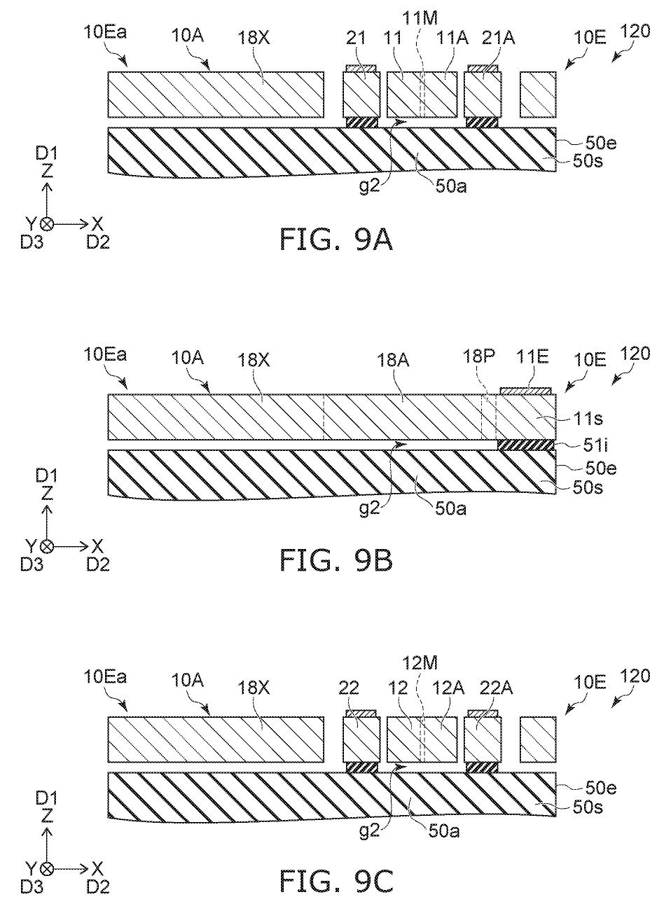

FIGS. 9A to 9C are schematic cross-sectional views illustrating a part of the sensor according to the first embodiment.

FIG. 9A is a cross-sectional view taken along the line A1-A2 in FIG. 8A. FIG. 9B is a cross-sectional view taken along the line A3-A4 in FIG. 8A. FIG. 9C is a cross-sectional view taken along the line A5-A6 in FIG. 8A. In these figures, the first structure 60 and the first intermediate member 41 are omitted.

As shown in FIG. 7, in the sensor 120 according to the embodiment, the sensor section 10E also includes the sensor base 50s and the first sensor section 10Ea. The sensor base 50s includes the first region 50a, the second region 50b and the first end portion 50e. The first region 50a is between the second region 50b and the first end portion 50e.

As shown in FIG. 8A, the first sensor section 10Ea includes the first support portion 11s, the first movable portion 10A, and the first fixed electrode 21. As shown in FIG. 9B, the first support portion 11s is fixed to the first region 50a. The first movable portion 10A is supported by the first support portion 11s. The first fixed electrode 21 is fixed to the first region 50a. The second gap g2 is provided between the first region 50a and the first movable portion 10A.

As shown in FIG. 8A, in the sensor 120, the first movable portion 10A may further include a first movable base portion 18A, a second movable base portion 18B, and a first beam 11M. The first movable base portion 18A is connected to the first support portion 11s. A part of the first beam 11M is connected to the first movable base portion 18A. Another part of the first beam 11M is connected to the second movable base portion 18B. For example, the first beam 11M extends along the third direction D3. The third direction D3 crosses a plane including the first direction D1 and the second direction D2. The third direction D3 may be, for example, the Y-axis direction. The first movable electrode 11 is connected to the first beam 11M.

For example, the resonance frequency of the first beam 11M may change due to acceleration applied to the sensor section 10E. The change in the resonance frequency may be detected by the first signal Sg1 generated between the first movable electrode 11 and the first fixed electrode 21. The acceleration may be detected by detecting the change in the resonance frequency.

As shown in FIG. 8A, the first movable portion 10A may include a first movable connecting portion 18P. The first movable connecting portion 18P is provided between the first movable base portion 18A and the first support portion 11s. The first support portion 11s supports the first movable connecting portion 18P. The first movable connecting portion 18P supports the first movable base portion 18A. A length (width) of the first movable connecting portion 18P along the third direction D3 is shorter than a length (width) of the first movable base portion 18A along the third direction D3. For example, the first movable base portion 18A may be deformed (or displaced) so as to rotate within the X-Y plane around the first movable connecting portion 18P.

For example, the deformation (or displacement) of the first movable base portion 18A applies stress to the first beam 11M. The stress generated in the first beam 11M changes the resonant frequency of the first beam 11M. The change in the resonant frequency is detected, and thus acceleration is detected. By providing the first movable connecting portion 18P with a narrow width, the deformation (displacement) of the first movable base portion 18A due to acceleration becomes large. High sensitivity is obtained.

As shown in FIG. 8A, the first movable portion 10A may include a first movable component 18X. The first movable component 18X is connected to the first movable base portion 18A. For example, the first movable base portion 18A is provided between the first movable component 18X and the first support portion 11s in the second direction D2. The first movable connecting portion 18P is provided between the first movable base portion 18A and the first support portion 11s in the second direction D2.

A length (width) of the first movable component 18X along the third direction D3 is longer than a length (width) of the first movable base portion 18A along the third direction D3. By providing the first movable component 18X, the deformation (displacement) of the first movable base portion 18A in response to acceleration can be made large. The first movable component 18X functions as a proof mass, for example.

As shown in FIG. 8A and FIG. 9C, the first sensor section 10Ea may further include a second fixed electrode 22. The second fixed electrode 22 is fixed to the first region 50a. The first movable portion 10A may further include a second movable electrode 12. The second movable electrode 12 faces the second fixed electrode 22 in the second direction D2.

The first movable portion 10A may further include a second other movable base portion 18BM and a second beam 12M. A part of the second beam 12M is connected to the second other movable base portion 18BM. Another part of the second beam 12M is connected to the first movable base portion 18A. The second beam 12M extends along the third direction D3. In this example, a direction from the second beam 12M to the first beam 11M is along the third direction D3.

The second movable electrode 12 is connected to the second beam 12M. For example, the first resonant frequency of the first beam 11M and the second resonant frequency of the second beam 12M change depending on the acceleration applied to the sensor section 10E. The change in the resonant frequency corresponds to, for example, a change in stress applied to the beam.

In one state of acceleration, when the first resonant frequency increases, the second resonant frequency decreases. In another state of acceleration, when the first resonant frequency decreases, the second resonant frequency increases. By detecting the change in the difference between the two resonant frequencies, the acceleration can be detected with higher sensitivity. The acceleration can be detected with higher accuracy. The detected acceleration includes a component in a direction crossing the first direction D1. In this example, the detected acceleration includes, for example, a component in the third direction D3.

As shown in FIG. 8A, the first sensor section 10Ea may further include the first other fixed electrode 31 and the second other fixed electrode 32. The first other fixed electrode 31 and the second other fixed electrode 32 are fixed to the first region 50a. The first other fixed electrode 31 faces the first movable electrode 11. The second other fixed electrode 32 faces the second movable electrode 12. In this example, in the second direction D2, at least a part of the first movable electrode 11 is between the first fixed electrode 21 and the first other fixed electrode 31. In the second direction D2, at least a part of the second movable electrode 12 is between the second fixed electrode 22 and the second other fixed electrode 32.

For example, an AC signal is applied between the first movable electrode 11 and the first other fixed electrode 31. This AC signal causes the first beam 11M to vibrate. A change in the first resonant frequency of the first beam 11M due to acceleration may be detected by the first signal Sg2 between the first fixed electrode 21 and the first movable electrode 11.

For example, an AC signal is applied between the second movable electrode 12 and the second other fixed electrode 32. This AC signal causes the second beam 12M to vibrate. A change in the second resonant frequency of the second beam 12M due to acceleration may be detected by a second signal between the second fixed electrode 22 and the second movable electrode 12.

The first other fixed electrode 31 and the second other fixed electrode 32 are, for example, drive electrodes. The first fixed electrode 21 and the second fixed electrode 22 are, for example, detection electrodes.

As shown in FIG. 8A, in this example, the first sensor section 10Ea further includes a first opposing fixed electrode 21A, a second opposing fixed electrode 22A, a first opposing other fixed electrode 31A, and a second opposing other fixed electrode 32A. These fixed electrodes are fixed to the first region 50a.

As shown in FIG. 8A, in this example, the first movable portion 10A includes a first opposing movable electrode 11A and a second opposing movable electrode 12A. The first opposing fixed electrode 21A faces the first opposing movable electrode 11A in the second direction D2. The first opposing other fixed electrode 31A faces the first opposing movable electrode 11A in the second direction D2. In this example, the first opposing movable electrode 11A is between the first opposing fixed electrode 21A and the first opposing other fixed electrode 31A. The second opposing fixed electrode 22A faces the second opposing movable electrode 12A in the second direction D2. The second opposing other fixed electrode 32A faces the second opposing movable electrode 12A in the second direction D2. In this example, the second opposing movable electrode 12A is between the second opposing fixed electrode 22A and the second opposing other fixed electrode 32A.

As shown in FIG. 9B, for example, the first movable portion 10A may include a first movable portion electrode 11E. The first movable portion electrode 11E is electrically connected to the first movable electrode 11, the second movable electrode 12, the first opposing movable electrode 11A, and the second opposing movable electrode 12A.

As shown in FIG. 8B, the controller 70 may be provided. The controller 70 may be configured to supply drive signals (e.g., AC signals) to the first other fixed electrode 31, the second other fixed electrode 32, the first opposing other fixed electrode 31A, and the second opposing other fixed electrode 32A, for example.

The controller 70 may be electrically connected to the first fixed electrode 21, the second fixed electrode 22, the first opposing fixed electrode 21A, and the second opposing fixed electrode 22A, for example. The controller 70 may be configured to detect signals between each of these fixed electrodes and the first movable portion 10A.

In the embodiment, acceleration may be detected based on the detection result of the difference between the first resonant frequency of the first beam 11M and the second resonant frequency of the second beam 12M. As already explained, in the embodiment, for example, adverse effects due to thermal stress are suppressed. For example, stress relaxation due to creep is suppressed. For example, changes in the resonant frequency due to thermal stress are suppressed.

For example, changes in the distance between the first movable electrode 11 and the first fixed electrode 21 due to temperature changes are suppressed. For example, the effects of changes in the soft spring effect due to electrostatic springs are suppressed.

In the embodiment, the sensor section 10E may include other sensor sections (such as a second sensor section).

### Second Embodiment

The second embodiment relates to an electronic device.

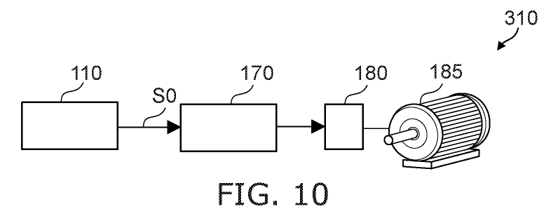

FIG. 10 is a schematic diagram illustrating an electronic device according to the second embodiment.

As shown in FIG. 10, an electronic device 310 according to the embodiment includes the sensor according to the first embodiment and a circuit controller 170. In the example of FIG. 10, the sensor 110 is illustrated as the sensor. The circuit controller 170 is configured to control a circuit 180 based on a detected signal S0 obtained from the sensor. The circuit 180 is, for example, a control circuit of a driving device 185 or the like. According to the embodiment, for example, the circuit 180 for controlling the driving device 185 can be controlled with high accuracy.

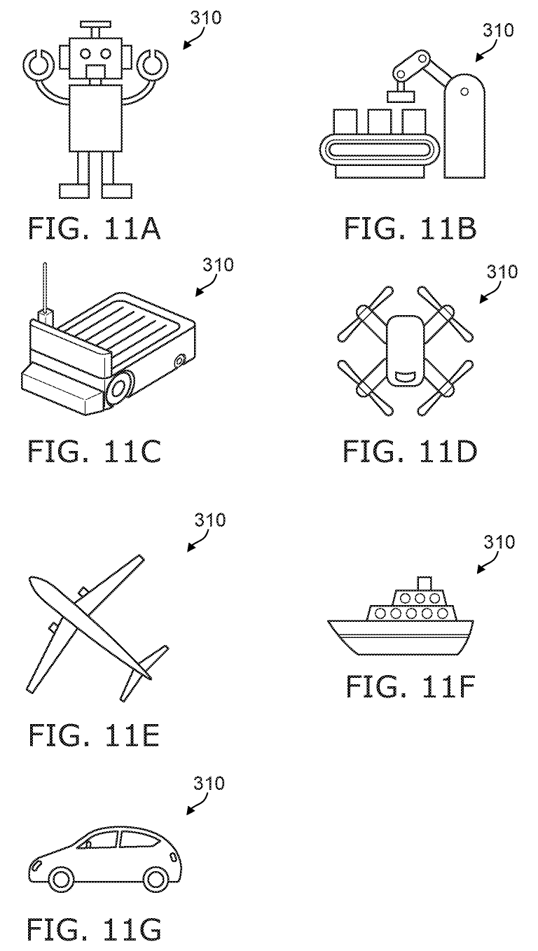

FIGS. 11A to 11G are schematic diagrams illustrating applications of the electronic device according to the embodiment.

As shown in FIG. 11A, the electronic device 310 may be at least a part of a robot. As shown in FIG. 11B, the electronic device 310 may be at least a part of a work robot provided in a manufacturing factory or the like. As shown in FIG. 11C, the electronic device 310 may be at least a part of an automated guided vehicle such as in a factory. As shown in FIG. 11D, the electronic device 310 may be at least a part of a drone (unmanned aerial vehicle). As shown in FIG. 11E, the electronic device 310 may be at least a part of an airplane. As shown in FIG. 11F, the electronic device 310 may be at least a part of a vessel. As shown in FIG. 11G, the electronic device 310 may be at least a part of an automobile. The electronic device 310 may include, for example, at least one of a robot or a mobile object.

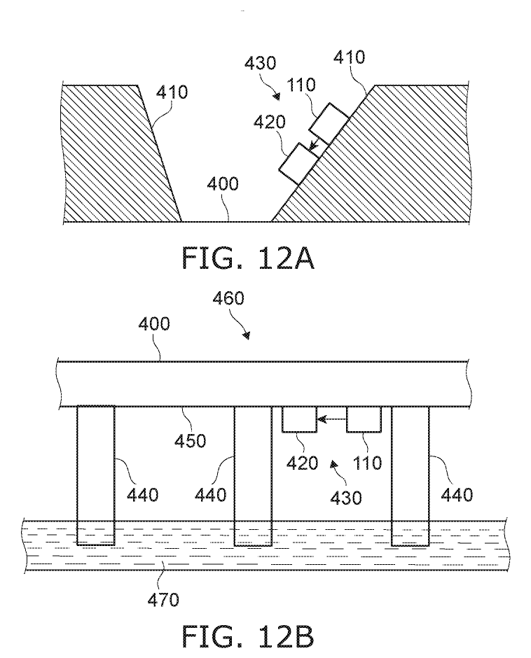

FIGS. 12A and 12B are schematic diagrams illustrating applications of the sensor according to the embodiment.

As shown in FIG. 12A, a sensor 430 according to the embodiment includes the sensor according to the first embodiment and a transmitter/receiver 420. In the example of FIG. 12A, the sensor 110 is drawn as the sensor. The transmitter/receiver 420 is configured to transmit the signal obtained from the sensor 110 by at least one of wireless or wired methods, for example. The sensor 430 is provided, for example, on a slope surface 410 such as a road 400. The sensor 430 may, for example, monitor conditions such as facilities (e.g., infrastructure). The sensor 430 may be, for example, a condition monitoring device.

For example, the sensor 430 detects changes in the state of the slope surface 410 of the road 400 with high accuracy. A change in the state of the slope surface 410 includes, for example, at least one of a change in tilt angle or a change in vibration state. The signal (test result) obtained from the sensor 110 is transmitted by the transmitter/receiver 420. The condition of facilities (e.g., infrastructure) can be monitored, e.g., continuously.

As shown in FIG. 12B, the sensor 430 is provided on a part of a bridge 460, for example. The bridge 460 is provided over a river 470. For example, the bridge 460 includes at least one of main girder 450 and a bridge pier 440. The sensor 430 is provided on at least one of the main girder 450 and the bridge pier 440. For example, the angle of at least one of the main girder 450 and the bridge pier 440 may change due to deterioration or the like. For example, in at least one of the main girder 450 and the bridge pier 440, the vibration state may change. The sensor 430 detects these changes with high accuracy. A detection result can be transmitted to an arbitrary place by the transmitter/receiver 420. Anomalies can be effectively detected.

The embodiments include the following Technical proposals:

### Technical proposal 1

A sensor, comprising:

a first structure including a first member region,

a first intermediate member, the first intermediate member including

a first intermediate fixing region fixed to the first member region, and

a first intermediate movable portion supported by the first intermediate fixing region,

a first gap being provided between the first member region and the first intermediate movable portion;

a sensor section; and

a first fixing member,

the sensor section including a sensor base and a first sensor section,

the sensor base including a first region, a second region and a first end portion,

the first intermediate movable portion being between the first member region and the second region in a first direction,

the second region being fixed to the first intermediate movable portion,

the first region being between the second region and the first end portion in a second direction crossing the first direction,

the first fixing member being between the first intermediate movable portion and the second region,

the first fixing member fixing the second region to the first intermediate movable portion,

the first fixing member not overlapping the first region in the first direction,

the first sensor section including:

a first support portion, at least a part of the first support portion being fixed to the first region;

a first movable portion supported by the first support portion, the first movable portion including a first movable electrode; and

a first fixed electrode fixed to the first region and facing the first movable electrode,

a second gap being provided between the first region and the first movable portion, and

the first end portion being a free end.

### Technical proposal 2

The sensor according to Technical proposal 1, wherein

a position of the first region in the first direction is between a position of the first member region in the first direction and a position of the first movable portion in the first direction.

### Technical proposal 3

The sensor according to Technical proposal 2, wherein

at least a part of the first intermediate fixing region is between the first member region and the second region in the first direction.

### Technical proposal 4

The sensor according to any one of Technical proposals 1-3, wherein

a third gap is provided between the first intermediate fixing region and the second region.

### Technical proposal 5

The sensor according to any one of Technical proposals 1-4, wherein

a position of the first region in the second direction is between a position of the first fixing member in the second direction and a position of the first end portion in the second direction.

### Technical proposal 6

The sensor according to Technical proposal 5, wherein

the first intermediate member includes a plurality of the first fixing members.

### Technical proposal 7

The sensor according to any one of Technical proposals 1-6, wherein

the first intermediate member further includes a first intermediate connecting portion provided between the first intermediate fixing region and the first intermediate movable portion,

the first intermediate connecting portion connects the first intermediate movable portion to the first intermediate fixing region, and

a length of the first intermediate connecting portion along a first extending direction in which the first intermediate connecting portion extends is longer than a length of the first intermediate connecting portion along a first extending crossing direction that crosses the first extending direction.

### Technical proposal 8

The sensor according to any one of Technical proposals 1-7, wherein

the first intermediate member further includes a second intermediate fixing region fixed to the first member region,

the second intermediate fixing region supports the first intermediate movable portion,

the first intermediate movable portion is between the first intermediate fixing region and the second intermediate fixing region in a cross direction that crosses the first direction.

### Technical proposal 9

The sensor according to Technical proposal 8, wherein

the first intermediate member further includes a second intermediate connecting portion provided between the first intermediate movable portion and the second intermediate fixed region,

the second intermediate connecting portion connects the first intermediate movable portion to the second intermediate fixed region, and

a length of the second intermediate connecting portion along a second extending direction in which the second intermediate connecting portion extends is longer than a length of the second intermediate connecting portion along a second extending crossing direction that crosses the second extending direction.

### Technical Proposal 10

The sensor according to any one of Technical proposals 1-7, wherein

the first intermediate member further includes a third intermediate fixing region fixed to the first member region,

the third intermediate fixing region supports the first intermediate movable portion, and

a direction from the first intermediate fixing region to the first intermediate movable portion crosse a direction from the third intermediate fixing region to the first intermediate movable portion.

### Technical Proposal 11

The sensor according to Technical proposal 10, wherein

the first intermediate member further includes a third intermediate connecting portion provided between the first intermediate movable portion and the third intermediate fixed region,

the third intermediate connecting portion connects the first intermediate movable portion to the third intermediate fixed region, and

a length of the third intermediate connecting portion along a third extending direction in which the third intermediate connecting portion extends is longer than a length of the third intermediate connecting portion along a third extending crossing direction that crosses the third extending direction.

### Technical proposal 12

The sensor as according to Technical proposal 10 or 11, wherein

the first intermediate member further includes a fourth intermediate fixing region fixed to the first member region,

the fourth intermediate fixing region supports the first intermediate movable portion, and

the first intermediate movable portion is between the third intermediate fixing region and the fourth intermediate fixing region.

### Technical proposal 13

The sensor according to Technical proposal 12, wherein

the first intermediate member further includes a fourth intermediate connecting portion provided between the first intermediate movable portion and the fourth intermediate fixed region,

the fourth intermediate connecting portion connects the first intermediate movable portion to the fourth intermediate fixed region, and

a length of the fourth intermediate connecting portion along a fourth extending direction in which the fourth intermediate connecting portion extends is longer than a length of the fourth intermediate connecting portion along a fourth extending crossing direction that crosses the fourth extending direction.

### Technical proposal 14

The sensor according to any one of Technical proposals 1-13, wherein

the first structure further includes an opposing member region,

the first intermediate member and the sensor section are provided between the first member region and the opposing member region, and

a fourth gap is provided between the sensor section and the opposing member region.

### Technical proposal 15

The sensor according to any one of Technical proposals 1-14, wherein

a first rate of change of a first curvature of the first region in the second direction with respect to temperature is smaller than a second rate of change of a second curvature of the second region in the second direction with respect to temperature.

### Technical proposal 16

The sensor according to any one of Technical proposals 1-15, further comprising:

a first mounting fixing member fixing the first intermediate fixing region to the first member region.

### Technical proposal 17

The sensor according to any one of Technical proposals 1-16, wherein

the first sensor section further includes a first other fixed electrode fixed to the first region,

the first movable electrode is between the first other fixed electrode and the first fixed electrode.

### Technical proposal 18

The sensor according to any one of Technical proposals 1-17, wherein

a first signal generated between the first movable electrode and the first fixed electrode changes according to an acceleration applied to the sensor section.

### Technical proposal 19

The sensor according to any one of Technical proposals 1-17, wherein

the first movable portion further includes a first movable base portion, a second movable base portion, and a first beam,

a part of the first beam is connected to the first movable base portion,

another part of the first beam is connected to the second movable base portion,

the first beam extends along a third direction,

the third direction crosses a plane including the first direction and the second direction,

the first movable electrode is connected to the first beam,

the first sensor section further includes a second fixed electrode fixed to the first region,

the first movable portion further includes a second movable electrode,

the second movable electrode faces the second fixed electrode in the second direction,

the first movable portion further includes a second other movable base portion and a second beam,

a part of the second beam is connected to the second other movable base portion,

another part of the second beam is connected to the first movable base,

the second beam extends along the third direction,

the second movable electrode is connected to the second beam, and

a first resonant frequency of the first beam and a second resonant frequency of the second beam change according to an acceleration applied to the sensor section.

### Technical proposal 20

An electronic device, comprising:

a sensor according to any one of Technical proposals 1-19; and

a circuit controller configured to control a circuit based on a signal obtained from the sensor.

The embodiments provide sensors and electronic devices that can improve performance.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as first structures, sensor sections, sensor base portions, support portions, fixed electrodes, movable portions, fixed members, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors and all electronic devices practicable by an appropriate design modification by one skilled in the art based on the sensors and the electronic devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a first structure including a first member region,
a first intermediate member, the first intermediate member including
a first intermediate fixing region fixed to the first member region, and
a first intermediate movable portion supported by the first intermediate fixing region,
a first gap being provided between the first member region and the first intermediate movable portion;
a sensor section; and
a first fixing member,
the sensor section including a sensor base and a first sensor section,
the sensor base including a first region, a second region and a first end portion,
the first intermediate movable portion being between the first member region and the second region in a first direction,
the second region being fixed to the first intermediate movable portion,
the first region being between the second region and the first end portion in a second direction crossing the first direction,
the first fixing member being between the first intermediate movable portion and the second region,
the first fixing member fixing the second region to the first intermediate movable portion,
the first fixing member not overlapping the first region in the first direction,
the first sensor section including:
a first support portion, at least a part of the first support portion being fixed to the first region;
a first movable portion supported by the first support portion, the first movable portion including a first movable electrode; and
a first fixed electrode fixed to the first region and facing the first movable electrode,
a second gap being provided between the first region and the first movable portion, and
the first end portion being a free end.

2. The sensor according to claim 1, wherein
a position of the first region in the first direction is between a position of the first member region in the first direction and a position of the first movable portion in the first direction.

3. The sensor according to claim 2, wherein
at least a part of the first intermediate fixing region is between the first member region and the second region in the first direction.

4. The sensor according to claim 1, wherein
a third gap is provided between the first intermediate fixing region and the second region.

5. The sensor according to claim 1, wherein
a position of the first region in the second direction is between a position of the first fixing member in the second direction and a position of the first end portion in the second direction.

6. The sensor according to claim 5, wherein
the first intermediate member includes a plurality of the first fixing members.

7. The sensor according to claim 1, wherein
the first intermediate member further includes a first intermediate connecting portion provided between the first intermediate fixing region and the first intermediate movable portion,
the first intermediate connecting portion connects the first intermediate movable portion to the first intermediate fixing region, and
a length of the first intermediate connecting portion along a first extending direction in which the first intermediate connecting portion extends is longer than a length of the first intermediate connecting portion along a first extending crossing direction that crosses the first extending direction.

8. The sensor according to claim 1, wherein
the first intermediate member further includes a second intermediate fixing region fixed to the first member region,
the second intermediate fixing region supports the first intermediate movable portion,
the first intermediate movable portion is between the first intermediate fixing region and the second intermediate fixing region in a cross direction that crosses the first direction.

9. The sensor according to claim 8, wherein
the first intermediate member further includes a second intermediate connecting portion provided between the first intermediate movable portion and the second intermediate fixed region,
the second intermediate connecting portion connects the first intermediate movable portion to the second intermediate fixed region, and
a length of the second intermediate connecting portion along a second extending direction in which the second intermediate connecting portion extends is longer than a length of the second intermediate connecting portion along a second extending crossing direction that crosses the second extending direction.

10. The sensor according to claim 1, wherein
the first intermediate member further includes a third intermediate fixing region fixed to the first member region,
the third intermediate fixing region supports the first intermediate movable portion, and
a direction from the first intermediate fixing region to the first intermediate movable portion crosse a direction from the third intermediate fixing region to the first intermediate movable portion.

11. The sensor according to claim 10, wherein
the first intermediate member further includes a third intermediate connecting portion provided between the first intermediate movable portion and the third intermediate fixed region,
the third intermediate connecting portion connects the first intermediate movable portion to the third intermediate fixed region, and
a length of the third intermediate connecting portion along a third extending direction in which the third intermediate connecting portion extends is longer than a length of the third intermediate connecting portion along a third extending crossing direction that crosses the third extending direction.

12. The sensor as according to claim 10, wherein
the first intermediate member further includes a fourth intermediate fixing region fixed to the first member region,
the fourth intermediate fixing region supports the first intermediate movable portion, and
the first intermediate movable portion is between the third intermediate fixing region and the fourth intermediate fixing region.

13. The sensor according to claim 12, wherein
the first intermediate member further includes a fourth intermediate connecting portion provided between the first intermediate movable portion and the fourth intermediate fixed region,
the fourth intermediate connecting portion connects the first intermediate movable portion to the fourth intermediate fixed region, and
a length of the fourth intermediate connecting portion along a fourth extending direction in which the fourth intermediate connecting portion extends is longer than a length of the fourth intermediate connecting portion along a fourth extending crossing direction that crosses the fourth extending direction.

14. The sensor according to claim 1, wherein
the first structure further includes an opposing member region,
the first intermediate member and the sensor section are provided between the first member region and the opposing member region, and
a fourth gap is provided between the sensor section and the opposing member region.

15. The sensor according to claim 1, wherein
a first rate of change of a first curvature of the first region in the second direction with respect to temperature is smaller than a second rate of change of a second curvature of the second region in the second direction with respect to temperature.

16. The sensor according to claim 1, further comprising:
a first mounting fixing member fixing the first intermediate fixing region to the first member region.

17. The sensor according to claim 1, wherein
the first sensor section further includes a first other fixed electrode fixed to the first region,
the first movable electrode is between the first other fixed electrode and the first fixed electrode.

18. The sensor according to claim 1, wherein
a first signal generated between the first movable electrode and the first fixed electrode changes according to an acceleration applied to the sensor section.

19. The sensor according to claim 1, wherein
the first movable portion further includes a first movable base portion, a second movable base portion, and a first beam,
a part of the first beam is connected to the first movable base portion,
another part of the first beam is connected to the second movable base portion,
the first beam extends along a third direction,
the third direction crosses a plane including the first direction and the second direction,
the first movable electrode is connected to the first beam,
the first sensor section further includes a second fixed electrode fixed to the first region,
the first movable portion further includes a second movable electrode,
the second movable electrode faces the second fixed electrode in the second direction,
the first movable portion further includes a second other movable base portion and a second beam,
a part of the second beam is connected to the second other movable base portion,
another part of the second beam is connected to the first movable base,
the second beam extends along the third direction,
the second movable electrode is connected to the second beam, and
a first resonant frequency of the first beam and a second resonant frequency of the second beam change according to an acceleration applied to the sensor section.

20. An electronic device, comprising:
a sensor according to claim 1; and
a circuit controller configured to control a circuit based on a signal obtained from the sensor.
